(19) United States
(12) Patent Application Publication
(10) Pub. No.: US 2004/0052360 A1
(43) Pub. Date: Mar. 18, 2004

(54) Equipment and method for automatically screening and filtering disturbance for the incoming phone call

(76) Inventors: Tony Tsai, Taipei (TW); Ling Chang, Shanghai (CN)

Correspondence Address: BIRCH STEWART KOLASCH & BIRCH, PO BOX 747, FALLS CHURCH, VA, 22040-0747, US

(21) Appl. No.: 10/245,278

(22) Filed: Sep. 18, 2002

(51) Int. Cl. H04M 1/00; H04M 9/00

(52) U.S. Cl. 379/392.01

(57) ABSTRACT

An equipment for automatically screening and filtering a disturbance for an incoming phone call includes a screening data bank, a register device, a comparing module, and an output device. The screening data bank is used to store a screen data, and the register device is used to store the phone number information of the incoming phone call, when the phone transmitting device calls to the phone receiving device requesting for signal connection. Then, the comparing module automatically makes a comparison between the screening data and the phone number information of the incoming phone call. When the comparison results in a match, the output device issues a signal indicating that the line is busy to the phone transmitting device for rejecting the signal connection. When the comparison does not result in a match, the output device issues a signal for receiving the phone call, so as to inform the user to receive the phone call. The present invention also discloses a method for automatically screening and filtering a disturbance for an incoming phone call.

### BACKGROUND OF THE INVENTION

1. Field of the Invention

This invention relates to an equipment and a method for automatically screening and filtering a disturbance for an incoming phone call, and more particularly, relates to an equipment and a method, capable of filtering and identifying the phone call information of the incoming call that the user does not desire to receive, according to the phone call information of the record made by the mobile communication device, so as to provide the screening function with automatic filtering and canceling the disturbing phone call.

2. Description of Related Art

As the technology of communication network is developed in great progress, nowadays, the mobile phone or cellular phone has been one of the common communication tools. However, in the current situation, when the mobile phone is used to receive the international phone call and in some countries the domestic phone call, the system manager for the mobile phone usually makes charges to both parties. In particular, it is often for the user nowadays to receive the international phone call or to use the mobile phone in the foreign countries while on a business trip or personal travel to foreign countries. Thus, the user often would be charged the phone call bill, by the communication company, without actually dialing out the phone call.

In addition to this situation, the user in the some specific situations wishes to screen out some phone calls from some phone numbers, so as to avoid the disturbance to the user caused by those phone calls. For example, during the off work or vacation period, the user may not want to receive the phone calls from the clients or calls relating the business.

In the conventional technology, in order to solve the foregoing problems, the mobile phones in current market have the function to show the information about the incoming phone call. In other words, when the incoming phone call is made, the displaying panel will display the phone number of the incoming phone call. The user can determine whether or not receive the phone call, according to the phone number. In other words, the user can determine whether or not by the user himself to receive some specific phone calls, for example to exclude from receiving some phone calls from the strangers. However, in some situations that are not proper for receiving the phone call, if the user does not receive the phone call, it may cause the unnecessary confusion to the caller.

As described in the foregoing situations, it has been a necessary issueto develop a method to automatically perform the filtering and screening function for the incoming phone call, based on the information of phone number and so on of the incoming phone call.

### SUMMARY OF THE INVENTION

It is therefore an objective of the present invention to provide an equipment and a method for automatically screening and filtering a disturbance for an incoming phone call, so as to achieve the mobile communication device with the function of automatically filtering the phone number with respect to the incoming phone call.

In accordance with the foregoing objective, the first step of the present invention is to perform a setup according to the user's requirements, so as to set up a screening data bank for the phone numbers, which need to be screened, and to further verify the phone numbers. As a result, when a phone call is dialed up, the mobile phone of the user would automatically verify the number of the phone call with the screening data bank, so as to automatically filter out the phone number in the screening data bank and to respond with a signal indicating that the line is busy.

In accordance with the foregoing and other objectives of the present invention, the present invention provides an equipment for automatically screening and filtering a disturbance for an incoming phone call, which comprises a screening data bank, a register device, a comparing module, and an output device. In the present invention, according to the equipment for automatically screening and filtering a disturbance for an incoming phone call of the present invention, it can be applied to a phone receiving device. The screening data bank stores the phone call data to be screened. The register device is used to store the information of the phone number with respect to the incoming phone call, wherein information is transmitted from the phone transmitting device to the phone receiving device when the phone transmitting device calls the phone receiving device for a signal connection. Then, the comparing module automatically makes a comparison between the screening data and the information of phone number of the incoming phone call. If the comparing result from the comparing module is a match, then the output device then issues a signal indicating that the line is busy to the phone transmitting device for rejecting the connection of the signal. If the comparing result from the comparing module is not a match, then the output device issues a signal for receiving the phone call, so that the user can receive the phone call.

In addition, the present invention also provides a method for automatically screening and filtering a disturbance for an incoming phone call. The first step of the method is providing a screening data bank. The screening data bank comprises at least one screening data. Then, when a phone transmitting device calls a phone receiving device to have the signal connection, it is received for the phone number information with respect to the incoming phone call transmitted from the phone transmitting device to the phone receiving device. Also, the phone number information is stored in a register device. Next, it is automatically compared for a match between the screening data and the phone number information of the incoming phone call. If the screening data bank has stored the screening data that is a match with the incoming phone number information, then the phone receiving device issues a line busy signal to the phone transmitting device for rejecting the signal connection. However, if the screen data bank has stored the screen data that does not include the same phone number information as the incoming phone call, then a receiving signal is issued via the phone receiving device, so as to inform the user to answer the phone call.

The equipment and the method in the present invention for automatically screening and filtering a disturbance for an incoming phone call first perform the setting process according to the need of the user, so as to build up the screening data bank of the phone numbers, which are necessary to be screened, for identification. In this manner, it can base on the phone number information of the incoming phone call to perform the filtering and to achieve the function of automatic screening for the incoming phone call without requiring manual operation by the user to determine whether or not to receive the phone call.

### BRIEF DESCRIPTION OF DRAWINGS

The invention can be more fully understood by reading the following detailed description of the preferred embodiments, with reference made to the accompanying drawings, wherein:

FIG. 1 is a drawing of block diagram, schematically illustrating the architecture for the equipment for automatically screening and filtering a disturbance for an incoming phone call, according to one embodiment of the present invention;

FIGS. 2a-2b are the process flow diagrams, schematically illustrating the method for automatically screening and filtering a disturbance for an incoming phone call, according to one embodiment of the present invention; and

FIG. 3 is a drawing, schematically illustrating the screen phone number information stored in the screening data bank in the equipment and the method for automatically screening and filtering a disturbance for an incoming phone call, according to one embodiment of the present invention.

### DETAILED DESCRIPTION OF PREFERRED EMBODIMENTS

In the following description, the equipment and the method for automatically screening and filtering a disturbance for an incoming phone call according to the embodiments of the present invention with drawings are provided, in which the same elements are indicated with the same reference number.

This embodiment is associating with a mobile phone communication system, which takes the GSM mobile phone communication system, as an example. If the phone transmitting device uses the public switched telephone network (PSTN) to call the phone receiving device, which is portable and is wireless, the exchanging unit of the PSTN would first transmit the phone number of the phone transmitting device to the interrogating exchange. Then, the interrogating exchange would inquire the home location register (HLR), so as to get the visitor location register (VLR) with respect to this phone number. After the VLR receives the inquiring request, it would transmit the mobile station roaming number (MSRN), which is respect to the phone receiving device, to the interrogating exchange. Then, the interrogating exchange according to the MSRN would have the signal connection with the mobile switching center (MSC), which is in the region where the phone receiving device is located.

No matter which type of dialing manner is used by the phone transmitting device, such as the dual-tone multiple frequency (DTMF) or the frequency shift keying (FSK), the caller identification of the phone transmitting device always can be transmitted via the PSTN and the wireless network. As a result, the phone receiving device can receive the caller identification of the phone transmitting device.

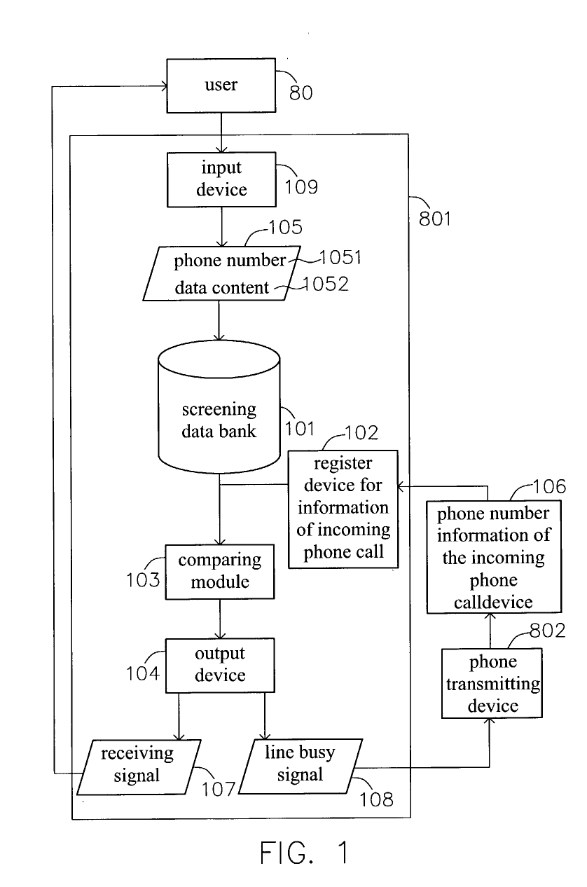

Referring to FIG. 1, the equipment 1 for automatically screening and filtering a disturbance for an incoming phone call according to the embodiment of the present invention is applied to a phone receiving device 801 and includes a screening data bank 101, a register device 102, a comparing module 103, and an output device 104.

The screening data bank 101 is used to store a screen data 105 inputted by the user 80. The register device 102 is used to store the phone number information 106 with respect to the incoming phone call, when a phone transmitting device 802 calls to the phone receiving device 801 requesting for signal connection. The comparing module 103 automatically makes a comparison between the screening data 105 and the phone number information 106 of the incoming phone call. The output device 104 has an action according to the comparing result from the comparing module 103. When the comparison results in a match, the output device 104 issues a line busy signal 107 to the phone transmitting device 802 for rejecting the signal connection. When the comparison does not result in a match, the output device 104 issues a signal 108 for receiving the phone call, so as to inform the user to receive the phone call.

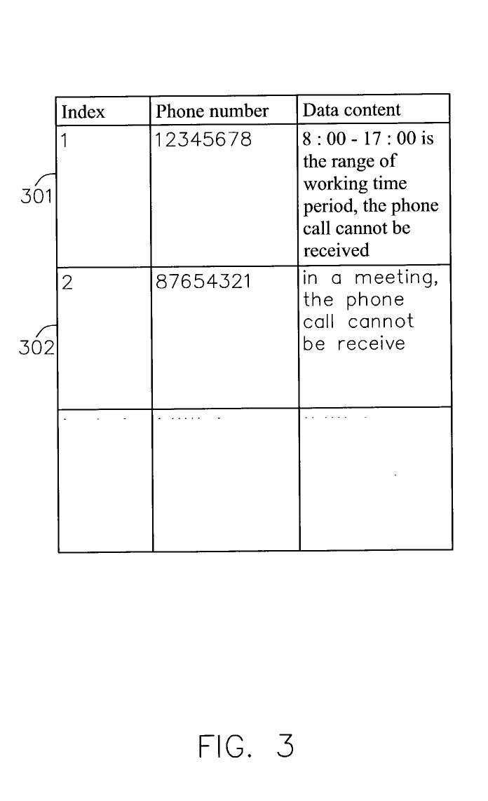

In the embodiment, the screening data 105 includes a phone number to be screened 1051 and a data content 1052. The data content 1052 includes a screening period with respect to the phone number to be screened 1051. Referring to the screening data shown in FIG. 3, a first batch of data 301 shown indicates that the phone number to be screened 1051 is “12345678”, and the data content 1052 of the issued line busy signal 107 is “8:00-17:00 is the range of working time period, the phone call cannot be received”. As shown in FIG. 3, the second batch of data 302 indicates that the phone number to be screened 1051 is “87654321”, and the data content 1052 of the issued line busy signal 107 is “in a meeting, the phone call cannot be received”.

In addition, in the embodiment, the screening data 105 is inputted by an input device 109. The input device 109 can include a standard keyboard of a consultative committee for international telephone and telegraph (CCITT) and at least one auxiliary input key. In this manner, the user 80 can input beforehand the phone numbers to be screened. The user 80 can directly use the CCITT standard keyboard to input the phone number character by character to the screening data bank 101, or use the auxiliary input key to save the phone numbers for the previous phone calls to the screening data bank 101, so that the screening data 105 is in the screening data bank 101.

In the embodiment, the phone receiving device 801 is a wireless portable telephone, which includes a microprocessor, a memory, and a storage device, wherein the memory can be a random access memory (RAM) or a flash memory, and the storage device can be a read only memory (ROM) or a flash memory. The foregoing screening data bank 101 and the comparing module 103 are stored in the storage device of the software module. The register device 102 is a part of the foregoing memory, and a comparing result of the comparing module 103 is obtained through the operation by the microprocessor.

In order to make the content of the present invention to be better understood, an embodiment is provided as follows to describe the method for automatically screening and filtering a disturbance for an incoming phone call 2 as shown in the process flow diagrams.

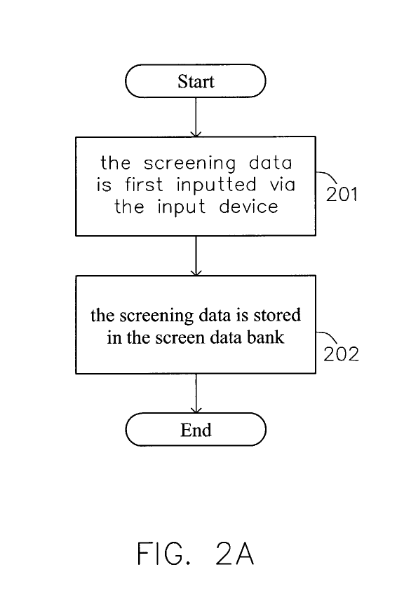

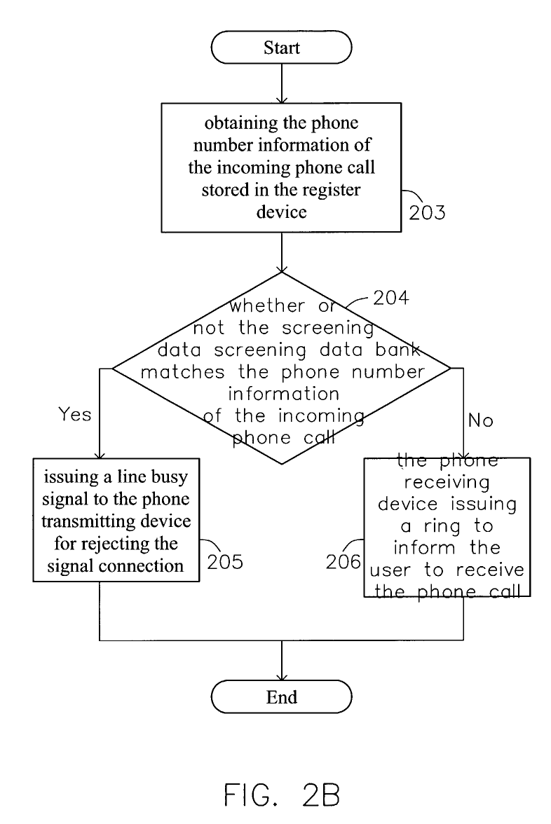

Referring to FIG. 2a, the steps of the method for automatically screening and filtering a disturbance for an incoming phone call 2 according the embodiment of the present invention include setting up a screening data bank 101, and then inputting the screening data 105 into the screening data bank 101. As described previously, the user 80 can use the CCITT standard keyboard to input the phone number character by character, or the auxiliary input key to save the phone numbers for the previous phone calls to the screening data bank 101, so that the screening data 105 is in the screening data bank 101.

Referring to FIG. 2b, when the phone transmitting device 802 calls a phone receiving device 801 to request a signal connection, the phone number information 106 with respect to the incoming phone call transmitted from the phone transmitting device 802 to the phone receiving device 801 is obtained. The register device 102 stores the phone number information 106 with respect to the incoming phone call. Finally, the screening data 105 and the phone number information 106 of the incoming phone call are automatically compared. When the comparison results in a match, the output device 104 issues a line busy signal 107 to the phone transmitting device 802 for rejecting the signal connection. When the screening data bank 101 has not stored one screen data 105 which is a match with the phone number information 106 of the incoming phone call, the output device 104 issues a receiving signal 108, so as to inform the user 80 to receive the phone call.

In the embodiment, the user 80 in the steps 201-202 builds up the screening data 105 beforehand as shown in FIG. 2a. In the step 201, the screening data 105 is first inputted via the input device 109. In the step 202, the screening data 105 is then stored in the screen data bank 101.

In addition, when the phone transmitting device 802 calls the phone receiving device 801 via the PSTN, the steps 203 to 206 are performed as shown in FIG. 2b. First in the step 203, the phone number information 106 of the incoming phone call stored in the register device 102 is first obtained. Then in the step 204, a comparing process is performed to automatically compare the screening data 105 stored in the screening data bank 101 with the phone number information 106 of the incoming phone call to see whether or not there is a match. When the screening data bank 01 has stored the screening data 105, which is the same as the phone number information 106 of the incoming phone call, then the step 205 is performed to issue a line busy signal 107 to the phone transmitting device for rejecting the signal connection. For example, when the phone number information 106 of the incoming phone call is “12345678”, then a message of “8:00-17:00 is the range of working time period, the phone call cannot be received” is sent to the phone transmitting device 802 and the line is disconnected. Similarly, when the phone number information 106 of the incoming phone call is “87654321”, then a message of “in a meeting, the phone call cannot be received” is sent to the phone transmitting device 802 and the line is disconnected. In addition, when the screening data bank 101 has not stored the screen data 105, which is the same as the phone number information 106 of the incoming phone call, the step of 206 is performed to generate a ringing signal via the phone receiving device 801 to inform the user 80 to receive the phone call.

In summary of the foregoing descriptions, the equipment and the method for automatically screening and filtering disturbance for an incoming phone call of the present invention allows the user to set the screening conditions according to the user's need, by building up the screening data bank for the phone numbers, which are desired to be screened, for the further identification. In this manner, when the phone transmitting device dials up the phone line, the phone receiving device of the user can automatically identify the phone number of the incoming phone call and automatically filter out the phone number, which has been stored in the screening data bank and automatically respond with a line busy signal. Therefore, the present invention can achieve the function of screening the incoming phone call by automatical filtering, according to the phone number information with respect to the incoming phone call. Thus, the user is not required to manually operate the phone in order to determine whether or not the phone call is to be received.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An equipment for automatically screening and filtering a disturbance for an incoming phone call, used in a phone receiving device, the equipment comprising:
a screening data bank, used to store a screen data;
a register device, used to store a phone number information of the incoming phone call when a phone transmitting device calls to the phone receiving device for the signal connection;
a comparing module, which can automatically make a comparison between the screening data and the phone number information of the incoming phone call; and
an output device, wherein if the comparison result from the comparing module is a match, then a line busy signal is issued for rejecting the signal connection, and if the comparison result from the comparing module is not a match, then a receiving signal is issued, so as to inform the user to receive the phone call.

2. The equipment for automatically screening and filtering a disturbance for an incoming phone call as recited in claim 1, wherein the screening data comprises a phone number to be screened and a data content.

3. The equipment for automatically screening and filtering a disturbance for an incoming phone call as recited in claim 2, wherein the data content comprises a screening period which is used to screen the phone number to be screened.

4. The equipment for automatically screening and filtering a disturbance for an incoming phone call as recited in claim 1, wherein the screening data is inputted via an input device, wherein the device is a standard keyboard of consultative committee for international telephone and telegraph (CCITT).

5. The equipment for automatically screening and filtering a disturbance for an incoming phone call as recited in claim 1, wherein the phone receiving device is a wireless and portable telephone.

6. A method for automatically screening and filtering a disturbance for an incoming phone call, the method comprising the steps of providing a screening data bank, the screening data bank comprising at least one screening data;
obtaining a phone number information of the incoming phone call transmitted from the phone transmitting device to the phone receiving device, and storing the phone number information in a register device when a phone transmitting device calls a phone receiving device for requesting a signal connection;
automatically comparing the screening data with the phone number information of the incoming phone call;
issuing a line busy signal for rejecting the signal connection via a output device, if the screening data bank has stored the screening data that is the same as the phone number information of the incoming phone call; and
issuing a receiving signal via the output device, so as to inform the user to receive the phone call, if the screen data bank has stored the screen data which does not include the same as the phone number information of the incoming phone call.

7. The method for automatically screening and filtering a disturbance for an incoming phone call as recited in claim 6, having a phone number to be screened and a data content.

8. The method for automatically screening and filtering a disturbance for an incoming phone call as recited in claim 6, wherein the data content comprises a screening period which is used to screen the phone number to be screened.

9. The method for automatically screening and filtering a disturbance for an incoming phone call as recited in claim 6, wherein the screening data is inputted via an input device and the input device is a standard keyboard of consultative committee for international telephone and telegraph (CCITT).

10. The method for automatically screening and filtering a disturbance for an incoming phone call as recited in claim 6, wherein the phone receiving device is a wireless and portable telephone.
